(19) United States
(12) Patent Application Publication
(10) Pub. No.: US 2025/0159318 A1
(43) Pub. Date: May 15, 2025

(54) IMAGING SENSOR ASSEMBLY

(71) Applicant: Maranon, Inc., Eagle Rock, VA (US)

(72) Inventor: James Thomas, Eagle Rock, VA (US)

(73) Assignee: Maranon, Inc., Eagle Rock, VA (US)

(21) Appl. No.: 18/533,548

(22) Filed: Dec. 8, 2023

Related U.S. Application Data
(60) Provisional application No. 63/431,211, filed on Dec. 8, 2022.

(51) Int. Cl. H04N 23/51; G02B 7/04; G02B 13/16; H04N 23/52; H04N 23/55

(52) U.S. Cl. CPC H04N 23/51; G02B 7/04; G02B 13/16; H04N 23/52; H04N 23/55

(57) ABSTRACT

The present image sensor assembly for imaging devices incorporates numerous features to allow for weight reduction and incorporation into the objective lens focus mechanisms of the imaging devices. The image sensor, image display, and if necessary, an image amplifier and/or power supply, are directly potted to imaging module housing. A flex circuit mounted to the module housing may incorporate electromagnetic interference filtering, ground circuits, and power. An objective snout mounted to the module housing allows for direct connection to the objective lens focus mechanism. This image sensor assembly may use recycled components from existing image sensor assemblies to reduce waste and cost.

### CROSS-REFERENCE TO RELATED APPLICATIONS

This application claims the benefit of prior-filed, co-pending U.S. Provisional Patent Application No. 63/431,211, filed on Dec. 8, 2022, the contents of which are incorporated herein by reference in their entirety.

### BACKGROUND OF THE INVENTION

The present application is directed to the field of imaging. More specifically, the present application is directed to the field of military and commercial image enhancement devices, and an improved image sensor assembly therefor.

Night vision and other imaging devices have generally been locked in an architecture that results in a heavy, sometimes cumbersome product. When worn on the human head, which may already be wearing other heavy equipment such as a combat helmet, the result is loss of attentiveness, physiological neck strain, and/or injury. In short, wearing the device can cause injury and be discomfiting. Such injury and/or loss of attentiveness can have severe negative consequences for a pilot or any mission critical imaging device operator.

Previous attempts to make lightweight imaging devices have focused on making individual devices lighter by removing unnecessary components or making components lighter by using lighter materials. However, there is only so much which can be removed from the existing architecture, and lighter materials often have a trade-off of being less robust.

The proposed imaging assembly is used as part of a modified imaging device which has integrated components and functions to modify system architecture for a lighter imaging device.

### BRIEF DESCRIPTION OF THE DRAWING(S)

FIGS. 1a and 1b illustrate exterior and cross-sectional views, respectively, of an embodiment of an imaging assembly.

FIG. 1c illustrates a cross-sectional view of another embodiment of an imaging assembly.

FIG. 2 illustrates a flow chart of an exemplary embodiment of a method for utilizing the components of an off-the-shelf imaging assembly in the imaging assembly.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

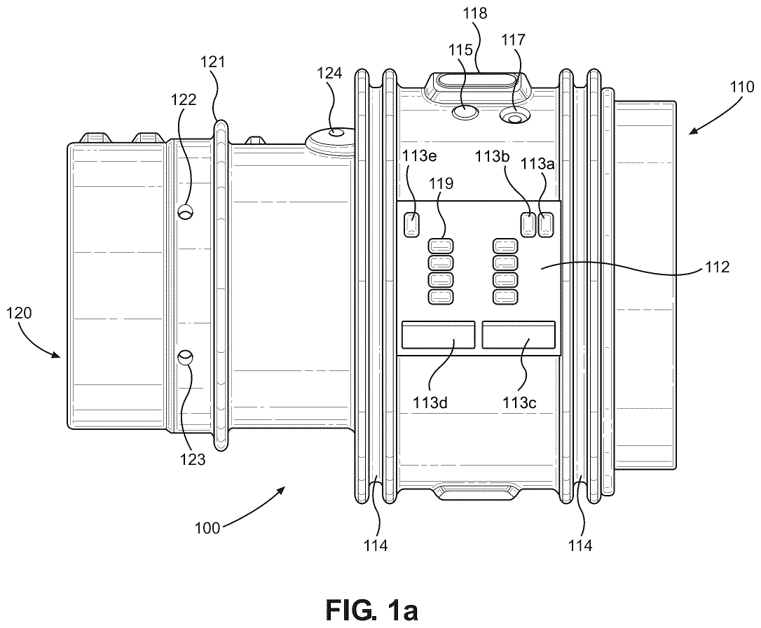

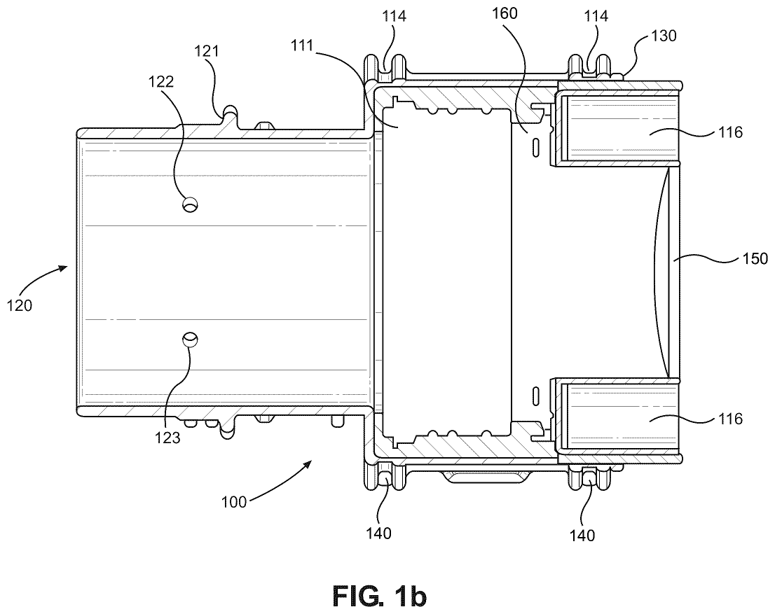

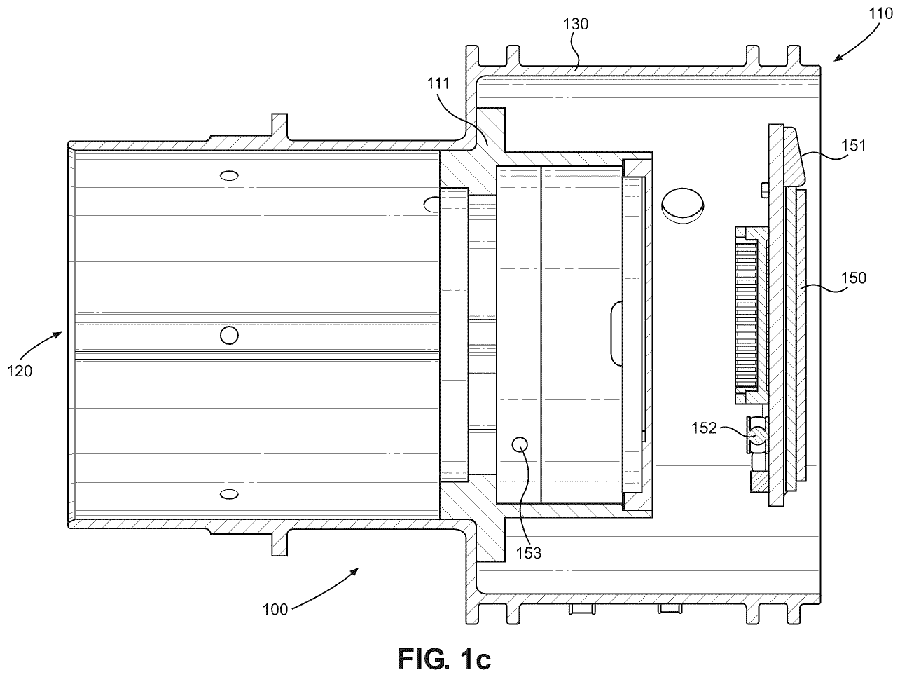

The image sensor assembly 100 shown in FIGS. 1a-1c includes a mechanical objective snout 120 mounted to a modified imaging module 110. The imaging module 110 includes a module housing 130. An image sensor 111 is located within the module housing 130. The image sensor 111 may be any image intensifier or imaging sensor of any kind known in the art for use in night vision or other image enhancing devices. By way of non-limiting example, in the embodiment shown in FIG. 1b, the image sensor 111 is a photocathode sensor. By way of non-limiting example, in the embodiment shown in FIG. 1c, the image sensor 111 is a camera sensor. It should further be understood that whenever the application refers solely to night vision devices, reference to all image-enhancing devices is included.

The objective snout 120 shown in FIG. 1a-1c has a hollow configuration with a sidewall extending between an open distal end and a proximal end connected to the module housing. This configuration allows the objective snout 120 to serve as a guide within which an objective lens subassembly or part thereof (not shown) may slide back and forth to adjust focus from infinity to close focus. In various embodiments, the means for moving the objective lens subassembly is mechanical, electrical, magnetic, or any combination thereof.

The objective snout 120 includes at least one objective focus screw aperture 123 extending through the sidewall for at least one focus screw (not shown). During assembly, the focus screw is inserted after the objective lens subassembly is inserted into the open distal end of the objective snout 120. After the focus screw or screws are installed, the objective lens subassembly may then be rotated for focusing. While the embodiment shown uses screws, other retaining mechanisms such as pins or any other retaining mechanism known in the art could be used. This allows the image sensor assembly 100 to be an integral part of an objective focus mechanism for obtaining focus in certain embodiments.

The objective snout 120 also acts as a female sealing surface for the objective lens subassembly. The objective snout 120 acts as an environmental seal from humidity, water, or other contaminants and to ensure that the objective lens subassembly and imaging sensor 111 are properly purged. Seal is made when the male components of the objective lens subassembly are inserted into the objective snout 120. The male components of the objective lens subassembly may include a structure similar to an O-ring seal but other embodiments are contemplated. Thus, the objective snout 120 becomes a second feature to demonstrate the image sensor assembly 100 can become part of the objective lens focus mechanism.

The image sensor assembly 100 also includes features for a diopter (eyepiece) focus. At least one grip retention flange 121 in the shape of a flange extending around the outer circumference of the objective snout 120 provides a surface which may retain a diopter adjustment grip (not shown). This diopter adjustment grip is slid over the outer circumference of the objective snout 120 and against this grip retention flange 121. Subsequently, a grip retainer ring (not shown) is also slid over the objective snout 120 after the diopter adjustment grip and is held in place against the objective snout 120 by at least one grip retention screw in at least one grip retention screw aperture 122. While the embodiment shown uses screws, other retaining mechanisms such as pins or any other retaining mechanism known in the art could be used. Thus, the diopter grip is sandwiched between the grip retention flange 121 and the retainer ring. The rest of the diopter adjustment mechanism such as threads that move an eyepiece back and forth may be located in other parts of the imaging device.

When the diopter grip is rotated, it is loaded against the grip retention flange 121 or the retainer ring, depending on direction of rotation, and the image sensor assembly 100 slides in and out to provide diopter focus in the imaging device. Thus, diopter adjustment features have now been integrated into the image sensor assembly 100 and the image sensor assembly 100 becomes an integral part of the diopter adjustment mechanism of the imaging device by including interface features for locking the diopter focus ring onto the image sensor assembly 100.

In various embodiments, the mechanical objective snout 120 may be connected to the module housing 130 or formed integrally with the module housing 130.

The image sensor assembly 100 also includes at least one sealing feature. In the embodiment shown in FIGS. 1a and 1b, the at least one sealing feature includes two sealing grooves 114 on the module housing 130 to hold two seals 140, by which the image sensor assembly 100 seals the diopter side of the imaging device from the external environment. These seals may be O-rings or any other seal known in the art.

The image sensor assembly 100 also includes at least one motion stop 118. In the present embodiment the motion stop 118 is a slotted “racetrack” oval on the module housing 130; however, other configurations may be used depending upon the desired magnitude, direction, and axis of movement of the image sensor assembly 100 within the imaging device. When the image sensor assembly 100 is installed into the imaging device, a protrusion such as, but not limited to, a screw or pin may enter into this slot from another assembly in the imaging device. Movement of image sensor assembly 100 relative to this protrusion is limited by the confines of the motion stop 118. In embodiments where the image sensor assembly 100 has a cylindrical configuration, the motion stop 118 prevents the image sensor assembly 100 from over-rotating about its longitudinal axis within the imaging device. This ensures that electrical connections between the image sensor assembly 100 and the imaging device remain uninterrupted. The motion stop 118 can also prevent the image sensor assembly 100 from being linearly over-extended along its longitudinal axis. This prevents the image sensor assembly 100 from traveling too far during diopter adjustment and either breaking purge on the diopter side or becoming jammed in another assembly.

Electrical power can be supplied to the image sensor assembly 100 in various modes without changing the intrinsic design of the image sensor assembly 100. In one embodiment, at least one power supply aperture 117 extending through the module housing 130 allows at least one wire (not shown) to also extend through the module housing 130. These wires could be routed anywhere in the imaging device. The simplest means would be an aperture in another assembly in the imaging device. The diameter of the at least one power supply aperture 117 allows the wires to slide back and forth.

In the embodiment shown in FIG. 1a, at least one flex circuit 112 may be attached to an outer surface of the module housing 130 by adhesives or other means available to one skilled in the art. In various embodiments, the various structures and capabilities of the at least one flex circuit 112 discussed below may be split between multiple interconnected or separate flex circuits 112. Ground and positive wires (not shown) may be attached to the flex circuit 112 by soldering or other means available to one skilled in the art. If a ground to the imaging module 110 is needed for electromagnetic interference (EMI) shielding, then a ground wire (not shown) may be spliced into a ground circuit on the flex circuit 112 at a first end and soldered to at least one ground post 115 at the other end. Certain other embodiments may replace the ground post 115 with conductive ground plating at least partially covering the imaging module 110. The splice may be made in various fashions ranging from at least one EMI pad 113e on the flex circuit 112 or simply a splice directly to the ground wire.

Additional options include running the ground and positive wires to ground and positive solder pads 113a and 113b, respectively. These solder pads 113a and 113b can be plated or otherwise applied directly to an exterior surface of the module housing 130 if EMI is not a concern. Even if EMI is a concern, other embodiments may also include conductive plating on the module housing 130 if the module housing 130 is made from non-conductive polymer material.

Alternatively, electrical pads 113c and 113d could be provided by the flex circuit 112. In certain embodiments, electrical pads 113c and 113d can provide travel surfaces for an electrical contact with another assembly of the imaging device to provide power to the imaging module 110. In various embodiments, the contact could be a roller contact, spring loaded plunger contact, leaf spring contract, any other method known to one skilled in the art, or any combination thereof. In such embodiments, the electrical pads 113c and 113d will extend along the module housing 130 or flex circuit 112 at least as far as the image sensor assembly 100 is intended to travel along its longitudinal axis in the imaging device to ensure uninterrupted contact.

In certain embodiments, another electrical pad 113 may be used for external gain adjustment. This electrical pad 113 can be placed on the flex circuit 112, connected to a wire (not shown) extending from at least one power supply 116 to perform external gain adjustment. Additional contact and/or solder pads 113 can be added by one skilled in the art as required for additional features.

An optional external EMI filter 119 may be used for embodiments intended for high EMI environments. This EMI filter 119 can be left off embodiments intended for low EMI environments. The optional EMI filter 119 may be formed on the flex circuit 112 attached to the imaging module 110. As described previously, the ground and positive wires may be soldered to the flex circuit 112; in this case, they may be soldered to the EMI filter 119. It should be noted that FIG. 1a shows separate pads 113a and 113b for the wires coming from the power supply 116 and separate pads 113c and 113d for interfacing with the rest of the device. However, certain embodiments may combine a solder pad 113a or 113b, an electrical pad 113c or 113d, and the optional EMI pad 113e into one strip or buss on the flex circuit 112 as a combined pad 113 that acts as a ground.

The image sensor assembly 100 also includes at least one purge aperture 124. In the embodiment shown in FIG. 1a, a purge aperture 124 is provided on the objective side of the image sensor assembly 100 extending through the sidewall of the objective snout 120 to provide a means of removing atmospheric humidity from the space in between the objective lens subassembly and the image sensor 111. The space is then filled with a dry, inert gas. Purge is performed after the objective lens subassembly is installed and is needed to prevent humidity from condensing on the image sensor 111 and impacting visual performance. Consequently, the objective side of the image sensor assembly 100 is purged independently from an opposite eyepiece side of the image sensor assembly 100 using a second purge aperture 124. In other embodiments, the purge aperture 124 accesses a shared volume in the image sensor assembly 100, allowing for simultaneous purging of both objective and eyepiece sides.

The image sensor assembly 100 also provides means of ensuring imaging device collimation. The seals 140 or a similar centering mechanism known in the art may be installed in the sealing grooves 114. These can act as springs which can center or otherwise position the optical and mechanical axes of the image sensor assembly 100 relative to other assemblies in the imaging device. This enables optical collimation of the imaging device.

The imaging module 110 further includes an image display 150 for displaying the image from the image sensor 111. By way of non-limiting example, in the embodiment shown in FIG. 1b, the image display 150 is a phosphor screen for use with a photocathode sensor. By way of non-limiting example, in the embodiment shown in FIG. 1c, the image display 150 is a digital screen for use with a camera. In certain embodiments, the image display 150 may be bundled into a unitary or sealed combination with the image sensor 111. One non-limiting example combines the photocathode sensor and phosphor screen as a sealed unit. If necessary, in certain embodiments an image amplifier 160 may be interconnected with the image sensor 111 and image display 150 to amplify the sensed image for easier or more perceptible viewing on the image display 150.

In various embodiments, the image display 150 may also include at least one display input/output port 151. The display input/output port 151 may be used for a variety of tasks, including, but not limited to, receiving images and other information from the image sensor 111 and other elements, and transmitting images and other information from the image display 150. The image display 150 may also include user controls 152 such as, but not limited to, adjustment of the image display 150, power controls, and controls for image sensor 111. In various embodiments, the image sensor 111 may also include at least one sensor input/output port 153. The sensor input/output port 153 may be used for a variety of tasks, including, but not limited to, transmitting images and other information from the image sensor 111 and receiving images and other information from other elements.

In certain embodiments, the image sensor assembly 100 includes additional elements, such as, but not limited to, optical filter elements on the input of the image sensor assembly 100, features for attaching at least one camera or display on the output of the image sensor assembly 100, and additional circuitry between sealing grooves 114.

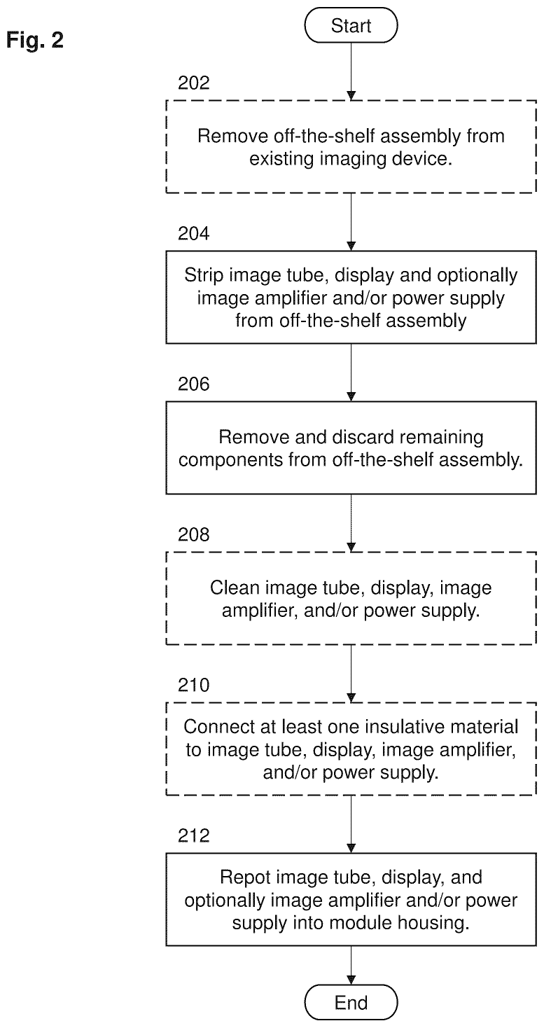

In certain embodiments, the imaging module 110 utilizes components removed and reused from a preexisting standard imaging module. Such reused components can include the image sensor 111, image display 150, image amplifier 160, power supply 116, and any necessary electrical contacts. The components removed from the standard imaging module may be retained or encapsulated by the module housing 130. Other embodiments may include components of a standard imaging module 110 removed from an existing imaging device and repotted in the module housing 130 using the below method 200 shown in FIG. 2.

Certain embodiments may also include the method 200 for utilizing the components of an off-the-shelf assembly in the image sensor assembly 100 described herein by removing and reusing these elements from the off-the-shelf assembly in the imaging module 110. In certain embodiments, the off-the-shelf assembly is an ANVIS night vision imaging assembly, or any other similar module.

In optional block 202, the method 200 removes the off-the-shelf assembly from an existing imaging device.

In block 204, the method 200 strips the image sensor 111, image display 150, and optionally the image amplifier 160 and/or power supply 116 from the off-the-shelf assembly.

In block 206, the method 200 removes and discards remaining components of the off-the-shelf assembly, such as, but not limited to, assembly housing, photocathode glass, and access glass.

In optional block 208, the method 200 cleans the image sensor 111, image display 150, image amplifier 160, and/or the power supply 116.

In optional block 210, the method 200 attaches, coats, or otherwise connects at least one insulative material to the image sensor 111, image display 150, image amplifier 160, and/or the power supply 116.

In block 212, the method 200 repots the image sensor 111, image display 150, and optionally the image amplifier 160 and/or power supply 116 into the module housing 130 to create the module 110 described above.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. An imaging assembly comprising:
an imaging module comprising an image sensor within a module housing; and
an objective snout connected to the module housing at a proximal end,
wherein an open distal end of the objective snout is configured to receive an objective lens subassembly.

2. The assembly of claim 1, wherein the image sensor is an image sensor recycled from a preexisting imaging module.

3. The assembly of claim 1, wherein the imaging module further comprises at least one flex circuit mounted to the module housing.

4. The assembly of claim 3, wherein the at least one flex circuit comprises at least one pad.

5. The assembly of claim 3, wherein the at least one flex circuit comprises an EMI filter.

6. The assembly of claim 1, wherein the module housing comprises at least one pad, wherein the at least one pad comprises conductive plating on an exterior surface of the module housing.

7. The assembly of claim 6, wherein the module housing comprises a non-conductive polymer material.

8. The assembly of claim 1, wherein the imaging module further comprises at least one image display.

9. The assembly of claim 8, further comprising at least one image amplifier interconnecting the image sensor and the at least one image display.

10. The assembly of claim 1, further comprising at least one sealing groove extending around a circumference of an outer surface of the module housing.

11. The assembly of claim 1, further comprising at least one ground post extending from an outer surface of the module housing.

12. The assembly of claim 1, wherein the imaging module further comprises at least one power supply.

13. The assembly of claim 12, wherein the at least one power supply is at least one power supply recycled from a preexisting imaging module.

14. The assembly of claim 1, wherein the imaging module comprises at least one power supply aperture extending through the module housing.

15. The assembly of claim 1, wherein the imaging module comprises at least one motion stop.

16. The assembly of claim 1, wherein the objective snout has a hollow configuration with a sidewall extending between the open distal end and the proximal end.

17. The assembly of claim 1, wherein the objective snout comprises at least one grip retention flange extending around an outer circumference of the objective snout.

18. The assembly of claim 17, further comprising at least one grip retention screw aperture extending through a sidewall of the objective snout.

19. The assembly of claim 1, wherein the objective snout comprises at least one objective focus screw aperture extending through a sidewall of the objective snout.

20. The assembly of claim 1, wherein the objective snout comprises at least one purge aperture extending through a sidewall of the objective snout.
